(19) United States
(12) Patent Application Publication
(10) Pub. No.: US 2002/0160737 A1
(43) Pub. Date: Oct. 31, 2002

(54) Method and apparatus for diversity antenna branch selection

(75) Inventor: James A. Crawford, San Diego, CA (US)

Correspondence Address: FITCH EVEN TABIN AND FLANNERY, 120 SOUTH LA SALLE STREET, SUITE 1600, CHICAGO, IL, 60603-3406, US

(73) Assignee: Magis Networks, Inc.

(21) Appl. No.: 09/800,231

(22) Filed: Mar. 6, 2001

(51) Int. Cl. H04B 1/06

(52) U.S. Cl. 455/272; 455/132

(57) ABSTRACT

A diversity antenna branch selection module includes first and second computation stages. The first computation stage computes an approximate bit error probability for each of K sub-carriers in an Orthogonal Frequency-Division Multiplexing (OFDM) signal for each of L different antenna branches n antenna branches at a time. The second computation stage processes the approximate bit error probabilities to identify a group of n of the L different antenna branches that minimizes an approximate bit error probability of a signal that will eventually be constructed from sub-carriers that are each received by any one of the n antenna branches in the identified group. The module is ideal for use in a system having n radio frequency receivers and for wireless local area network (WLAN) applications operating at high frequencies, such as 5 to 6 GHz, in multipath environments.

### CROSS-REFERENCE TO RELATED APPLICATION

This application is related to U.S. patent application Ser. No. 09/______, filed of even date herewith, entitled PROBING SCHEME FOR DIVERSITY ANTENNA BRANCH SELECTION, by inventor James A. Crawford, and identified by Attorney Docket No. 69902, the full disclosure of which is hereby fully incorporated into the present application by reference.

### BACKGROUND OF THE INVENTION

1. Field of the Invention

The present invention relates generally to radio frequency (RF) communications, and more specifically to diversity reception in RF communications.

2. Discussion of the Related Art

The market for home and office networking is developing at a phenomenal rate. A cost-effective, robust, high-performance wireless local-area network (WLAN) technology is needed for distributing multimedia information within the indoor environment. An example of one proposed solution that purports to address the performance requirements of the home market is the IEEE 802.11a standard, which operates in the 5-GHz UNII (unlicensed National Information Infrastructure) band and can achieve data rates as high as 54 Mbits/s, which is a significant improvement over other standards-based wireless technology. The 802.11a standard has some unique and distinct advantages over other wireless standards in that it uses a technology called Orthogonal Frequency-Division Multiplexing (OFDM) as opposed to spread spectrum. OFDM is a technology that is better suited for some of the problems associated with the indoor wireless environment, such as the phenomenon called “multipath.”

A multipath environment is created when radio frequency (RF) signals propagate over more than one path from the transmitter to the receiver. Alternate paths with different propagation times are created when the RF signal reflects from objects that are displaced from the direct path. In other words, multiple radio signals are received from reflections off walls, ceilings, floors, furniture, people and other objects. The direct and alternate path signals sum at the receiver antenna to cause constructive and destructive interference, which have peaks and nulls across the modulation spectrum. When the receiver antenna is positioned in a null, received signal strength drops and the communication channel is degraded or lost. The reflected signals may experience a change in polarization relative to the direct path signal. This multipath environment is typical of indoor and in-office WLANs.

An approach to addressing the multipath problem is to employ multiple receiver antenna elements in order to selectively receive a signal from more than one direction or from a slightly different position. This approach, known as “diversity”, is achieved when receiving signals at different points in space or receiving signals with different polarization. Diversity that is achieved by receiving signals at different points in space is known as spacial diversity, and diversity that is achieved by receiving signals with different polarization is known as polarization diversity. Other types of receive diversity include, but are not limited to, time diversity and frequency diversity. Performance is further enhanced by isolating the separate antennas.

Diversity reception is important for achieving good bit error rate (BER) performance over channels that exhibit substantial multipath like the indoor wireless channel. The objective of diversity reception is to make use of statistically independent signal streams to reduce the impact of severe multipath-related channel fading. Namely, each of L number of receiving antenna branches receives an independent fading version of the same information-bearing signal such that the probability that all the signal components will fade simultaneously is reduced considerably. The benefits of using receive diversity, as compared to no diversity, are dramatic. The complexity, however, of having L number of receivers for full L-branch diversity is rather expensive.

OFDM is a modulation method that, like all wireless transmission schemes, encodes data onto a radio frequency (RF) signal. Conventional single carrier transmission schemes encode data symbols onto one radio frequency. OFDM encodes multiple data symbols concurrently onto multiple frequencies, or “tones.” This results in very efficient use of bandwidth and provides robust communications in the presence of noise, intentional or unintentional interference, and reflected signals that degrade radio communications.

OFDM technology breaks one high-speed data signal into tens or hundreds of lower speed signals, which are all transmitted in parallel. The data is divided across the available spectrum into a set of tones. Each tone is orthogonal (independent or unrelated) to all the other tones. This arrangement includes even the adjacent tones and, therefore, eliminates the need for guard bands between them. OFDM achieves spectral efficiency because guard bands are only required around a set of tones (at the edges of the occupied frequency band).

Because OFDM is made up of many narrowband tones, frequency selective fading (as a result of multipath propagation) degrades only a small portion of the signal and has little or no effect on the remainder of the frequency components. This makes the OFDM system highly tolerant to multipath propagation and narrowband interference. Nevertheless, such frequency-selective fading can be severe to the affected portion of the signal and can affect the OFDM sub-channels differently across the RF bandwidth involved.

Thus, there is a need for a method, apparatus and/or system that overcomes these and other disadvantages by providing affordable diversity reception and reducing the effects of frequency-selective fading in OFDM communications.

### SUMMARY OF THE INVENTION

The present invention advantageously addresses the needs above as well as other needs by providing a method of performing diversity antenna selection. The method includes the steps of: taking measurements from L different antenna branches n antenna branches at a time; using the measurements to identify a group of n of the L different antenna branches that minimizes an approximate bit error probability of a signal that will eventually be constructed from sub-carriers that are each received by any one of the n antenna branches in the identified group of n antenna branches; and selecting the identified group of n antenna branches.

In another embodiment, the invention can be characterized as an apparatus that includes a diversity antenna selection module, with the diversity antenna selection module including a first computation stage and a second computation stage. The first computation stage is configured to compute an approximate bit error probability for each of K sub-carriers for each of L different antenna branches n antenna branches at a time. The second computation stage is configured to process the approximate bit error probabilities to identify a group of n of the L different antenna branches that minimizes an approximate bit error probability of a signal that will eventually be constructed from sub-carriers that are each received by any one of the n antenna branches in the identified group of n antenna branches.

In another embodiment, the invention can be characterized as a diversity antenna selection module. The module includes means for taking measurements from L different antenna branches n antenna branches at a time. Also included are means for using the measurements to identify a group of n of the L different antenna branches that minimizes an approximate bit error probability of a signal that will eventually be constructed from sub-carriers that are each received by any one of the n antenna branches in the identified group of n antenna branches. Means for selecting the identified group of n antenna branches are also included.

A better understanding of the features and advantages of the present invention will be obtained by reference to the following detailed description of the invention and accompanying drawings which set forth an illustrative embodiment in which the principles of the invention are utilized.

### BRIEF DESCRIPTION OF THE DRAWINGS

The above and other aspects, features and advantages of the present invention will be more apparent from the following more particular description thereof, presented in conjunction with the following drawings wherein:

FIG. 1 is a schematic diagram illustrating a system made in accordance with an embodiment of the present invention;

FIG. 2 is a timing diagram illustrating a conventional physical waveform;

FIG. 3 is a timing diagram illustrating a physical waveform made in accordance with another embodiment of the present invention;

FIG. 4 is a timing diagram illustrating a conventional PHY-layer frame structure according to the IEEE 802.11a standard;

FIG. 5 is a timing diagram illustrating a preamble portion for a PHY-layer frame structure made in accordance with another embodiment of the present invention;

FIG. 6 is a timing diagram illustrating a preamble portion for a PHY-layer frame structure made in accordance with another embodiment of the present invention;

FIG. 7 is a timing diagram illustrating a PHY-layer frame structure made in accordance with another embodiment of the present invention;

FIG. 8 is a timing diagram illustrating a PHY-layer frame structure made in accordance with yet another embodiment of the present invention;

FIG. 9 is an RF frequency spectrum diagram illustrating two different diversity branches;

FIG. 10 is a flowchart illustrating an exemplary antenna branch selection method in accordance with an embodiment of the present invention;

FIG. 11 is a block diagram illustrating an exemplary diversity antenna branch selection module made in accordance with an embodiment of the present invention;

FIGS. 12A and 12B are schematic diagrams illustrating an exemplary diversity antenna branch selection module and sub-carrier selection diversity module made in accordance with embodiments of the present invention; and

FIG. 13 is a schematic diagram illustrating in greater detail a portion of the diversity antenna branch selection module shown in FIG. 12B.

Corresponding reference characters indicate corresponding components throughout the several views of the drawings.

### DETAILED DESCRIPTION OF THE INVENTION

The following description is not to be taken in a limiting sense, but is made merely for the purpose of describing the general principles of the invention. The scope of the invention should be determined with reference to the claims.

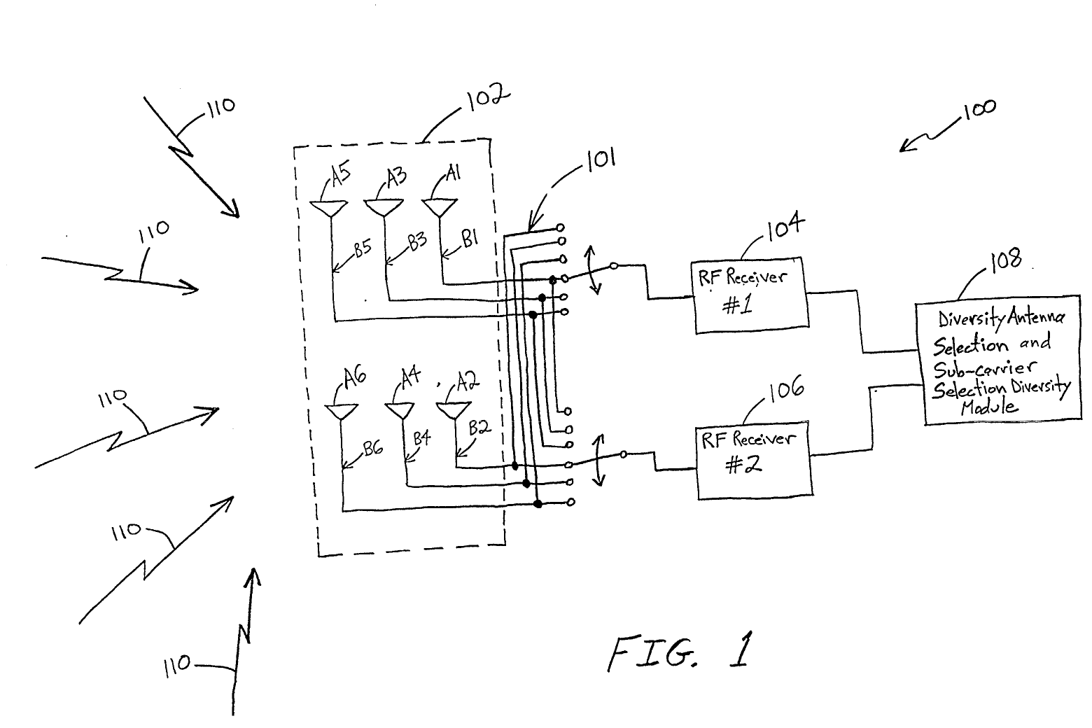

Referring to FIG. 1, there is illustrated a system 100 made in accordance with an embodiment of the present invention. The system 100 includes a diversity antenna 102, two radio-frequency (RF) receivers 104, 106, and a diversity antenna selection and sub-carrier selection diversity module 108. The system 100 can be manufactured for very low cost and is extremely well suited for wireless local area network (WLAN) applications operating at high frequencies, including the 5 to 6 GHz frequency band, in multipath environments where RF signals propagate over many different paths 110 from transmitter to receiver. Furthermore, the system 100 is well suited for use with multi-carrier modulation methods, such as Orthogonal Frequency Division Multiplexing (OFDM).

In this embodiment, the diversity antenna 102 includes six antenna branches B1, B2, B3, B4, B5, B6 connecting to six antenna elements A1, A2, A3, A4, A5, A6, respectively. The variable “L” is defined herein to represent the total number of antenna branches. Thus, L=6 for the illustrated diversity antenna 102. While the illustrated diversity antenna 102 includes six antenna branches B1, B2, B3, B4, B5, B6, it should be well understood that fewer or more than six antenna branches may be used in accordance with the present invention. In other words, L may be varied in accordance with the present invention.

By way of example, the diversity antenna 102 may comprise any of the antenna structures or antenna assemblies described in the following United States patent applications, which are hereby fully incorporated into the present application by reference: U.S. patent application Ser. No. 09/693,465, filed Oct. 19, 2000, entitled DIVERSITY ANTENNA STRUCTURE FOR WIRELESS COMMUNICATIONS, by inventor James A. Crawford; U.S. patent application Ser. No. 09/735,977, filed Dec. 13, 2000, entitled CARD-BASED DIVERSITY ANTENNA STRUCTURE FOR WIRELESS COMMUNICATIONS, by inventor James A. Crawford; and U.S. patent application Ser. No. 09/______, filed Mar. 5, 2001, entitled CONFORMAL BOX ANTENNA, by inventor James A. Crawford, and identified by Attorney Docket No. 69884.

The two parallel RF receivers 104, 106, along with the diversity antenna selection and sub-carrier selection diversity module 108, are used for implementing a diversity combining technique in accordance with an embodiment of the present invention. Specifically, it was mentioned above that diversity is an effective technique for achieving good bit error rate (BER) performance over channels that exhibit substantial multipath and frequency selective fading, like the indoor wireless channel. There are several known methods of diversity combining. For coherent modulation with independent branch fading, maximal ratio combining (MRC) is known as an optimal linear combining technique, but the hardware complexity for MRC is directly proportional to the number of available combining paths. In other words, the complexity of full L-fold MRC is fairly high due to the need for L-RF receivers, particularly when more complex QAM signal constellations are considered. The complexity of having L receivers for any type of full L-branch diversity is rather expensive. On the other extreme, selection combining (SC) is a simple combining technique, in which the branch with the largest amplitude (or signal to noise ratio (SNR)) is selected for demodulation.

A compromise between MRC and SC called second order selection combining (SC2) combines two branch signals that improves the BER performance relative to that achievable with SC and requires less complex hardware than MRC. In accordance with SC2, the system 100 preferably performs diversity selection in two stages: first, two antenna branches are selected from among the L antenna braches (the “diversity antenna branch selection” stage); and second, each final OFDM sub-carrier is selected from the two receiving RF channels which have been coupled to the two selected antenna branches (the “sub-carrier selection” stage). The two antenna branches selected during the diversity antenna branch selection stage are preferably chosen to be the best branches from the total choice of L=6 branches B1, B2, B3, B4, B5, B6. By using this two stage scheme, only the two parallel RF receivers 104, 106 are needed as opposed to L-RF receivers for full L-fold MRC or another type of full L-branch diversity.

The use of two parallel RF receivers 104, 106 is an ideal number of receivers in terms of hardware complexity and BER performance. It should be well understood, however, that more than two RF receivers, or only one RF receiver, may be used in accordance with some embodiments of the present invention. The variable “n” is defined herein to represent the number of available RF receivers. For example, if n=3, then three RF receivers are available and the system 100 preferably selects the three best branches from the total choice of L=6 branches during the diversity antenna branch selection stage. If n=1, then only one RF receiver is available and the system 100 preferably selects the one best branch from the total choice of L=6 branches. Note that in the case of n=1, the sub-carrier selection stage is not performed because each final OFDM sub-carrier must be selected from the one receiving RF channel. Thus, it should be well understood that the sub-carrier selection stage is itself an optional feature of the present invention. As an additional example, if L=4, then there are four antenna branches B1, B2, B3, B4 available and the system 100 can select the n best branches from the four available branches during the diversity antenna branch selection stage. In this example, if n=2, the system 100 selects the two best branches from the four available branches.

In accordance with an optional feature of the present invention, not all n of the available RF receivers must always be used. For example, if signal conditions are really good, software (or some other means) could choose to power-down one or more of the n available RF receivers and rely on less than n of the receivers to save power.

The function of selecting the two best branches (in the illustrated case of n=2) from the L=6 diversity branches B1, B2, B3, B4, B5, B6 available for examination is performed by the module 108. In general, the signal quality of each of the L different receive antenna elements A1, A2, A3, A4, A5, A6 is examined and the best two are selected. Specific methods that may be used for making this selection are described in detail below. The following discussion, however, first focuses on the timing of when antenna branch measurements (that will be used in the diversity antenna branch selection process) are made.

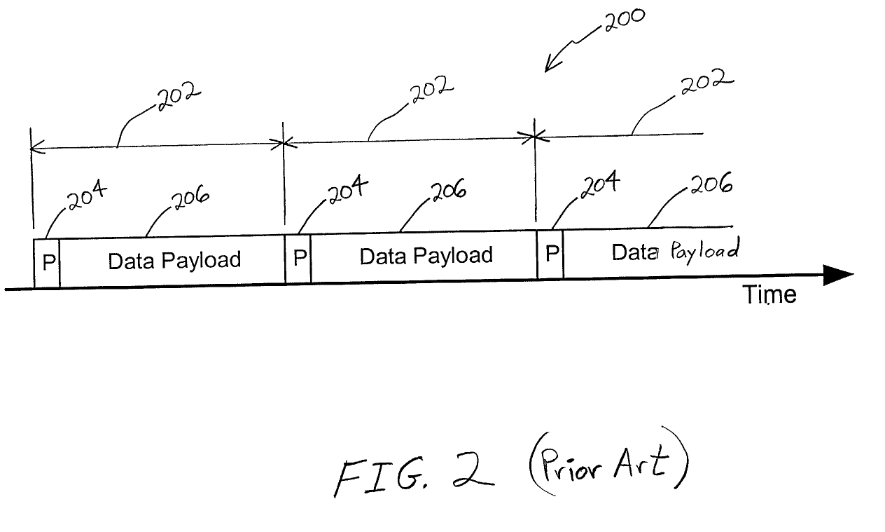

Antenna branch measurements are made during the reception of signals. Referring to FIG. 2, a conventional physical waveform 200 typically includes a series of PHY-layer frames 202, also known as a medium access control (MAC) frames. Each PHY-layer frame structure includes a preamble portion 204 and a data portion 206. The preamble portion 204 is typically used for signal detection, frequency offset estimation, timing synchronization and channel estimation. The data portion 206, of course, carries the data.

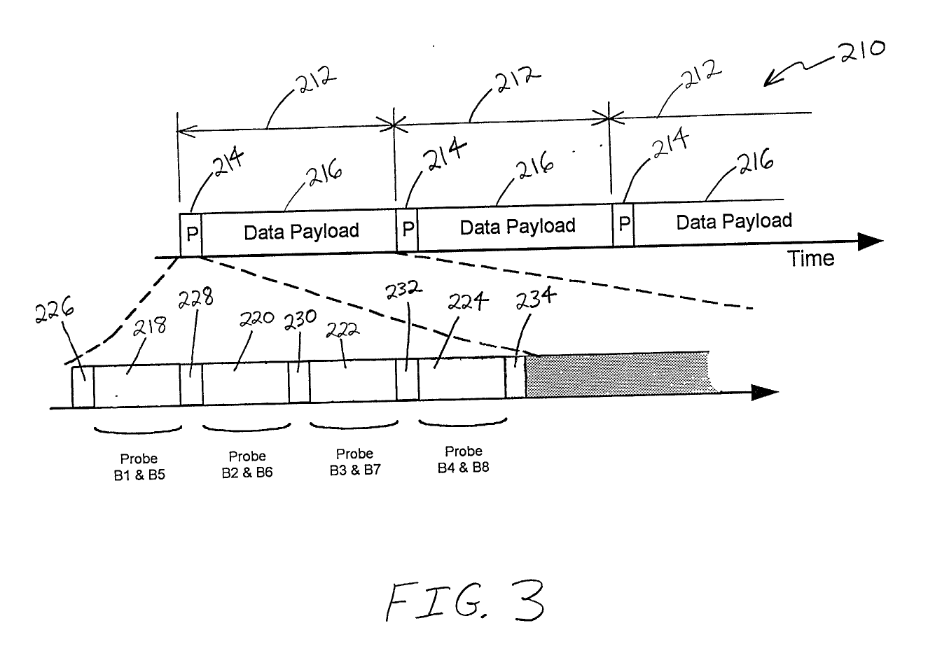

FIG. 3 illustrates a physical waveform 210 having PHY-layer frames 212 (or MAC frames 212) in accordance with one embodiment of the present invention. Each PHY-layer frame 212 includes a preamble portion 214 and a data portion 216. With the PHY-layer frames 212, the signal quality of each of L=8 different receive antenna branches B1, B2, B3, B4, B5, B6, B7, B8 is measured, or probed or scored, during the preamble portion 214. The preamble portion 214 takes advantage of the two complete RF receivers 104, 106 (FIG. 1) in that each probing sequence (or probing portion) is used to evaluate two antenna branches at a time. Specifically, antenna branches B1, B5 are probed during probing portion 218, antenna branches B2, B6 are probed during probing portion 220, antenna branches B3, B7 are probed during probing portion 222, and antenna branches B4, B8 are probed during probing portion 224. In this way the preamble portion 214 is used for probing the available diversity branches. Such antenna probing may also be referred to as antenna scoring.

The preamble portion 214 is preferably long enough, i.e., includes enough symbols, to permit all L antenna branches to be measured with sufficient signal-to-noise ratio for accurate results to be achieved. This may entail using multiple symbols for each antenna branch being so evaluated. Furthermore, one or more switching time intervals 226, 228, 230, 232, 234, or guard times 226, 228, 230, 232, 234, may be included to allow time for antenna branch switching. The switching time intervals 228, 230, 232 may be located between the antenna branch probing portions as illustrated. The switching time intervals 226, 234 may be located before the first antenna branch probing portion 218 and after the last antenna branch probing portion 224, respectively, as illustrated. The actual number of symbols used and the guard time for switching between branches may vary depending upon the specific application.

The antenna branch probing portions 218, 220, 222, 224 and the switching time intervals 226, 228, 230, 232, 234 form one exemplary version of what is referred to herein as a “diversity selection portion.” While this exemplary diversity selection portion is illustrated as being located in the preamble portion 214, the below discussion will make clear that the diversity selection portions described herein may be located anywhere in the PHY-layer frame (or MAC frame) in accordance with the present invention. Such diversity selection portions may also be referred to as antenna scoring waveforms.

It is noted that the illustrated preamble portion 214 is designed for use with L=8 antenna branches but could just as easily be used for L=6 antenna branches by eliminating the final probing portion 224 used for probing branches B4, B8. Similarly, the illustrated preamble portion 214 could be used for L=4 antenna branches by eliminating the final two probing portions 222, 224, or for L=2 antenna branches by eliminating the final three probing portions 220, 222, 224. In a further similar manner, the illustrated preamble portion 214 could be used for probing more than eight antenna branches (i.e., L>8) by adding additional probing portions to the preamble portion 214.

It is also contemplated that the illustrated preamble portion 214 could be modified to take advantage of more than two available RF receivers, or only one available RF receiver. For example, if three RF receivers are available (n=3), three antenna branches could be simultaneously probed during each probing portion (or probing sequence), and if four RF receivers are available (n=4), four antenna branches could be simultaneously probed during each probing portion, etc. If only one RF receiver is available (n=1), then only one antenna branch would be probed during each probing portion. Thus, the diversity branch probing scheme of the present invention allows the cycling through of all L antenna branches n-branches at a time.

In accordance with an optional feature of the present invention, the diversity branch probing scheme (or antenna scoring scheme) of the present invention may be enabled or disabled depending upon signal quality. For example, if signal conditions are relatively good, the diversity branch probing scheme may be performed less frequently, and if signal conditions are really good, the diversity branch probing scheme may be disabled. Such enabling and disabling may be performed by software or some other means.

The PHY-layer frames for many different standards-based wireless technologies may be modified to include the diversity branch probing scheme of the present invention. For example, OFDM for WLAN applications has been standardized in the IEEE 802.11a standard (in the U.S.) and HiperLAN2 standard (in Europe), both of which are incorporated into the present application by reference.

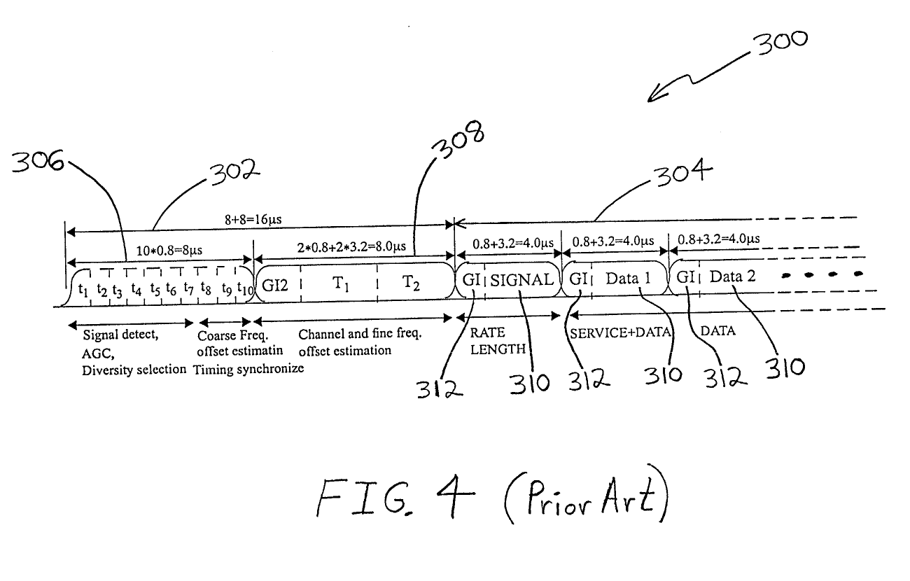

FIG. 4 illustrates the PHY-layer frame structure 300 for the IEEE 802.11a standard. The frame 300 (also known as a PHY-layer frame 300 or a MAC frame 300) includes a preamble portion 302 and a data portion 304. The preamble portion 302 includes a short symbol portion 306 and a long symbol portion 308. As shown in the figure, the short symbol portion 306 is used for signal detection, automatic gain control (AGC), diversity selection, coarse frequency offset estimation, and timing synchronization. The long symbol portion 308 is used for channel estimation and fine frequency offset estimation. The data portion 304 includes multiple symbols 310 (also referred to as OFDM symbols 310), each symbol 310 having a guard time interval 312 preceding it. This figure is the only place in the 802.11a standard that mentions diversity selection. It is believed that the present 802.11a standard provides inadequate time for effective diversity selection, if any at all. This is at least partly due to the difficulty of dealing with all of the data-bearing subcarriers used in the OFDM waveform before there has even been a coarse frequency estimate.

In modifying the IEEE 802.11a PHY-layer frame structure to include the diversity branch probing scheme of the present invention, the following analysis is taken into account. With respect to frame length, the frame length in 802.11a is variable, whereas the frame length used in HiperLAN2 is a fixed 2 msec frame. Short frames inherently lead to greater overhead loss, whereas long frames pose problems for both receive diversity systems as well as channel estimation methods.

One preferred maximum allowable frame length for some embodiments of the present invention is based upon the following RF-related analysis. In the indoor environment, it can be assumed that the multipath with be slow-changing with respect to time. At 5.35 GHz, a wavelength in free-space is 2.2 inches. If it is assumed that the maximum linear velocity of any object within the propagation volume is 20 feet per second or less (including doors shutting, venetian blinds vibrating, etc.), this velocity equates to 240 inches/second. If the maximum phase change between channel estimation/diversity operations is restricted to be 30 degrees in this present context, the maximum allowable time between updates is given by the following equation:

$$2 π \frac{v {T}_{f}}{λ} \leq {φ}_{max} \qquad ( 1 )$$

where v is the maximum linear velocity, T_{f} is the time between updates, and λ is the signal wavelength in free-space. For the conditions specified, T_{f}<0.76 msec. A frame size less than about 0.8 msec becomes prohibitive in terms of overhead. Therefore, a MAC frame size of 1.0 msec is ideal for supporting diversity and channel estimation processes in the PHY-layer, in accordance with one embodiment of the present invention, because it can easily be doubled in length to match the HiperLAN2 frame structure.

In the HiperLAN2 context where the symbol rate is 250 kHz, 0.76 msec corresponds to 190 OFDM symbol intervals, and 1.0 msec corresponds to 250 OFDM symbol intervals. This provides plenty of symbol intervals such that some of them can be allocated to probe the channels in order to determine which 2-of-L antenna branches are the best to choose. As mentioned above, the preamble portion 214 should preferably include enough OFDM symbols to permit all L antenna branches to be measured with sufficient signal-to-noise ratio (SNR) for accurate results to be achieved. A MAC frame size of 1.0 msec leaves plenty of symbol intervals for this purpose.

If a finer degree of coherency is sought, equation (1) can be used to derive many different MAC frame sizes that may be used in alternative embodiments of the present invention. For example, according to equation (1), the maximum RF carrier phase change between algorithm updates will be less than or equal to 10 degrees if the diversity branches are re-examined at least once every 0.25 msec. In the HiperLAN2 context a MAC frame size of 0.25 msec corresponds to about 63 OFDM symbol intervals, which still allows some of the symbol intervals to be allocated for probing the antenna branches.

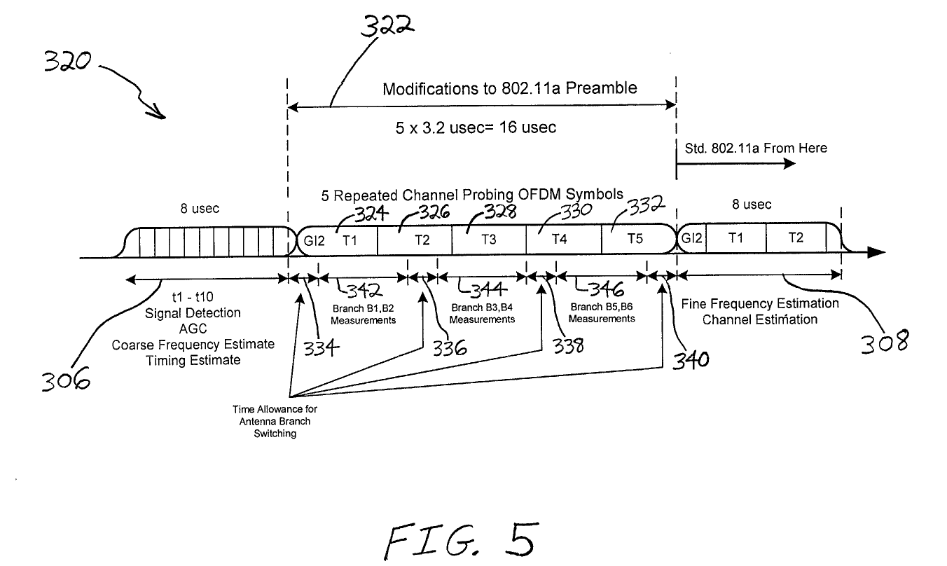

Turning to the preamble, the conventional 802.11a frame preamble is not sufficient to support the higher order diversity branch probing scheme of the present invention. Referring to FIG. 5, there is illustrated a diversity branch probing preamble 320 in accordance with one embodiment of the present invention. The diversity branch probing preamble 320 includes a diversity selection portion 322 inserted into the conventional 802.11a preamble so that it supports the diversity branch probing scheme of the present invention. The diversity selection portion 322 is a modification or enhancement to the conventional 802.11a preamble.

While the conventional 802.11a preamble 300 consists of 16 μsec as shown in FIG. 4, the diversity branch probing preamble 320 shown in FIG. 5 includes a total of up to 32 μsec. The diversity selection portion 322, which supports 6-branch receive diversity, includes five repeated channel probing long OFDM symbols 324, 326, 328, 330, 332. Because each long OFDM symbol is 3.2 μsec, the diversity selection portion 322 adds (5)(3.2 μsec)=16 μsec to the 802.11a preamble.

This orchestration of channel probing is purposely done to simplify the receiver hardware needed to support 2-of-L receive diversity. Specifically, because there are two complete receiver paths 104, 106 (FIG. 1), each probing sequence can be used to evaluate two branches at a time. Sufficient time has been included in the diversity selection portion 322 for RF switching. Namely, four switching time intervals 334, 336, 338, 340 are included to allow time for antenna branch switching. This way, in order to probe the available diversity branches, antenna branches B1, B2 are switched on (i.e., coupled to their respective receivers) during switching time interval 334 and then measured during probing portion 342, antenna branches B3, B4 are switched on during switching time interval 336 and then measured during probing portion 344, and antenna branches B5, B6 are switched on during switching time interval 338 and then measured during probing portion 346. The selected pair of antennas are switched on during the final switching time interval 340.

Advantageously, the diversity branch probing preamble 320 does not require accurate symbol time alignment while measuring the different diversity paths, postponing accurate time alignment until the long-symbol intervals. Furthermore, the diversity branch probing preamble 320 should be long enough for supporting high quality channel estimation when it comes to the dense signal constellations like 64-QAM (or higher) and also provide enough latitude to support channel estimation if necessary.

Although the illustrated OFDM symbols 324, 326, 328, 330, 332 comprise long OFDM symbols, it should be well understood that OFDM symbols of a different length may be used in the diversity selection portion 322 in alternative embodiments of the present invention. For example, it is noted that OFDM short symbols, such as those in the short-symbol portion 306 of the preamble 320, only make use of every 4^{th} subcarrier, and therefore cannot be used to probe all of the data-bearing subcarriers used in the OFDM waveform. However, OFDM short symbols could be used in the diversity selection portion 322 to measure diversity branches if probing only every 4^{th} subcarrier were found to be satisfactory. Furthermore, while the use of OFDM long and short symbols is convenient due to their inclusion in the 802.11a standard, symbols of various other designs may be used. Therefore, while a conservative approach is to use OFDM long symbols as illustrated, it should be well understood that the diversity selection portions described herein may comprise short symbols or symbols of any other design, length or type for implementing an antenna probing sequence in accordance with an embodiment of the present invention.

For simplicity, the signaling used for the OFDM symbol branch measurement probing portions can be the same as that used for the long symbol intervals T1 and T2 shown in the conventional 802.11a preamble 300 (FIG. 4). It should be well understood, however, that variations in the signaling may be used in accordance with the present invention.

It is noted that the illustrated diversity selection portion 322 is designed for use with L=6 antenna branches but could just as easily be used for more or fewer antenna branches by adding or eliminating one or more probing portions. For example, in an alternative embodiment of the present invention, only four repeated channel probing OFDM symbols T1, T2, T3, T4 are included to support four-branch receive diversity (L=4). This would allow enough time for two probing portions and associated switching time intervals. As an optional feature of the present invention, the PHY-layer hardware (discussed below) preferably includes the flexibility to be configured to (a) operate in the standard 802.11a mode, and (b) add a number of OFDM symbols to support L-branch diversity, such as for example, 4 (repeated) OFDM symbol intervals to support 4-branch diversity, 5 (repeated) OFDM symbol intervals to support 6-branch diversity, etc.

Table 1 provides a preamble overhead comparison of the standard 802.11a mode, an embodiment of the present invention supporting four-branch diversity, and an embodiment of the present invention supporting six-branch diversity.

TABLE 1
Preamble Overhead Comparison

| | | Time-Overhead | Time-Overhead |
|---|---|---|---|
| | Preamble | for 0.80 msec | for 1.0 msec |
| Standard | Length, μsec | Frame | Frame |
| 802.11a | 16 | 2.0% | 1.6% |
| Invention-4 Branch | 28.8 | 3.6% | 2.88% |
| Invention-6 Branch | 32 | 4.0% | 3.2% |

It is also contemplated that the illustrated diversity selection portion 322 of the preamble 320 could be used to take advantage of more than two available RF receivers, or only one available RF receiver. For example, if three RF receivers are available (n=3), three antenna branches could be simultaneously probed during each probing portion, and if four RF receivers are available (n=4), four antenna branches could be simultaneously probed during each probing portion, etc. If only one RF receiver is available, then only one antenna branch would be probed during each probing portion.

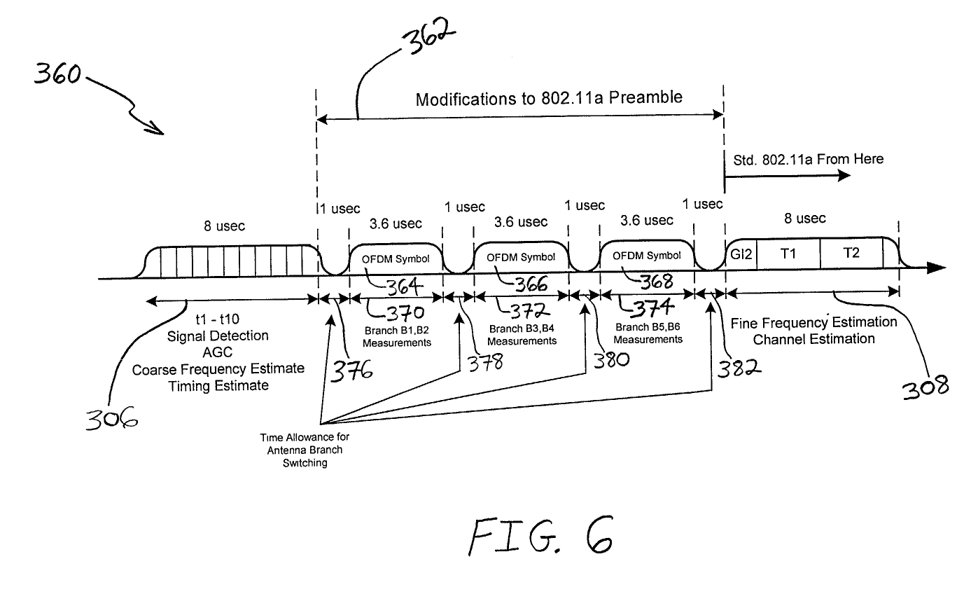

Referring to FIG. 6, there is illustrated a diversity branch probing preamble 360 in accordance with another embodiment of the present invention. The diversity branch probing preamble 360 includes a diversity selection portion 362 inserted into the conventional 802.11a preamble so that it supports the diversity branch probing scheme of the present invention. Three 3.6 μsec OFDM symbols 364, 366, 368 are included which correspond to the three probing portions 370, 372, 374, respectively. Four 1.0 μsec switching time intervals 376, 378, 380, 382 are also included to allow time for antenna branch switching. Unlike the diversity branch probing preamble 320 (FIG. 5), however, the diversity branch probing preamble 360 is most effective when symbol time alignment is performed due to the 1.0 μsec switching time intervals 376, 378, 380, 382 being interleaved with the OFDM symbols 364, 366, 368.

The diversity selection portions 322 (FIG. 5), 362 (FIG. 6) described above are shown as being located in the preamble of a MAC frame. It should be well understood, however, that the diversity selection portions described herein may be located anywhere in the MAC frame in accordance with the present invention. The receiver must know the location of the diversity selection portion in the MAC frame a priori.

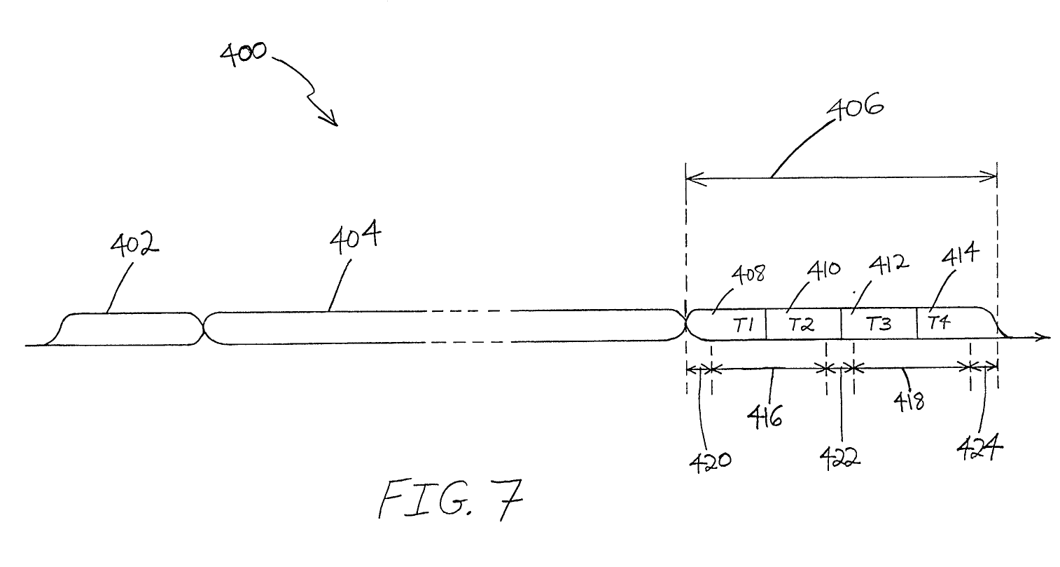

For example, referring to FIG. 7, there is illustrated a frame structure 400 in accordance with another embodiment of the present invention. The frame structure 400 preferably includes a preamble portion 402 and a data portion 404, which may comprise preamble and data portions in accordance with many different standards, such as for example the IEEE 802.11a standard or the HiperLAN2 standard. Following the data portion 404 is a diversity selection portion 406 used to implement the diversity branch probing scheme of the present invention. In this embodiment the diversity selection portion 406 can be referred to as a “postamble”.

The diversity selection portion 406 is similar to the diversity selection portion 322 (FIG. 5), except that four repeated channel probing OFDM long symbols 408, 410, 412, 414 are included instead of five. Because each OFDM symbol is 3.2 μsec, the diversity selection portion 406 adds (4)(3.2 μsec)=12.8 μsec to the frame structure 400. The four OFDM symbols 408, 410, 412, 414 support two probing portions 416, 418 and three switching time intervals 420, 422, 424 such that if two RF receivers are used (n=2), 4-branch (L=4) receive diversity is supported. Namely, in order to probe the available diversity branches, antenna branches B1, B2 are switched on (i.e., coupled to their respective receivers) during switching time interval 420 and then measured during probing portion 416, and antenna branches B3, B4 are switched on during switching time interval 422 and then measured during probing portion 418. The selected pair of antennas are switched on during the final switching time interval 424.

Placing the diversity selection portion 406 after the data portion 404 means that the fine frequency estimation that occurs at the end of the preamble portion 402 is completed for the antenna branch probing process. In contrast, for the diversity selection portion 322 (FIG. 5) the antenna branch probing process is performed before the fine frequency estimation occurs. Thus, the positioning of the diversity selection portion 406 after the data portion 404 provides a very convenient location.

It is noted that the illustrated diversity selection portion 406 is designed for use with L=4 antenna branches but could just as easily be used for more or fewer antenna branches by adding or eliminating one or more probing portions. It is also contemplated that the illustrated diversity selection portion 406 could be used to take advantage of more than two available RF receivers, or only one available RF receiver.

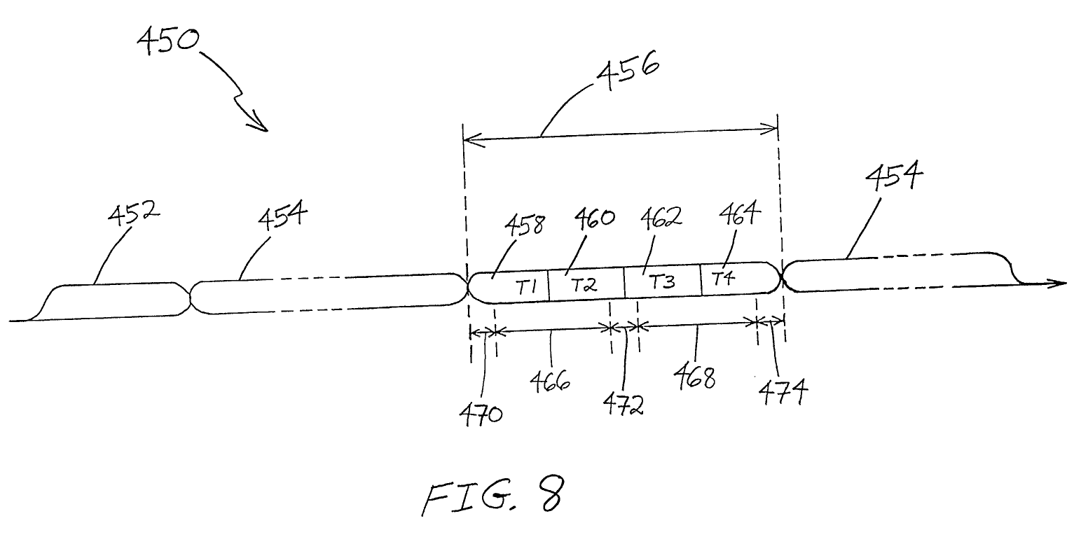

Referring to FIG. 8, there is illustrated a frame structure 450 in accordance with yet another embodiment of the present invention. The frame structure 450 also includes a preamble portion 452 and a data portion 454, which again may comprise preamble and data portions in accordance with many different standards, such as for example the IEEE 802.11a standard or the HiperLAN2 standard. In this embodiment, however, a diversity selection portion 456 used to implement the diversity branch probing scheme of the present invention is inserted in the data portion 454.

Similar to the diversity selection portion 406 (FIG. 7), four repeated channel probing OFDM long symbols 458, 460, 462, 464 are included which support two probing portions 466, 468 and three switching time intervals 470, 472, 474. If two RF receivers are used (n=2), 4-branch (L=4) receive diversity is supported. But again, however, more or fewer antenna branches could be supported by adding or eliminating one or more probing portions.

Thus, the diversity branch probing scheme of the present invention is an exemplary way to accommodate the selection diversity methodology that is discussed below. Given the hardware capability to process a predetermined number of complete RF channels in parallel (such as two RF channels as shown in FIG. 1), the diversity branch probing scheme of the present invention provides an efficient means for considering a large number of antenna branches from which the predetermined number of branches (e.g., two) are retained for actual processing. In other words, the diversity branch probing scheme of the present invention allows the cycling through of all L antenna branches n-branches at a time.

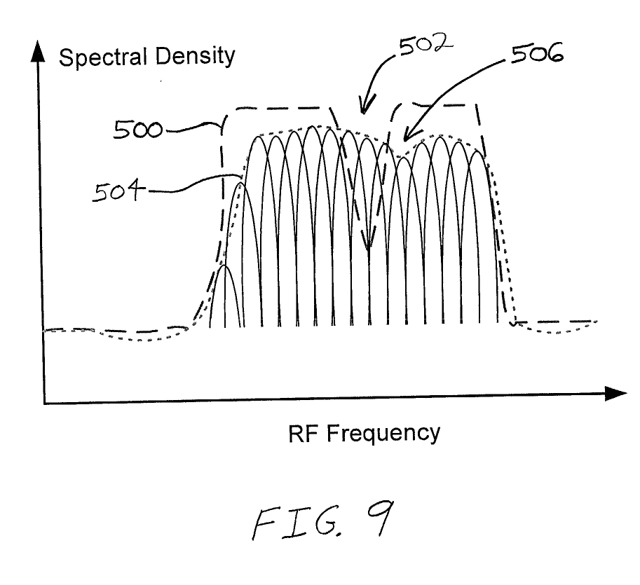

It was mentioned above that the function of selecting the two best branches from the L=6 diversity branches B1, B2, B3, B4, B5, B6 is performed by the diversity antenna selection and sub-carrier selection diversity module 108 (FIG. 1). Such selection diversity is somewhat complex with wideband OFDM in which many sub-carriers are involved along with frequency-selective fading. For example, the received signal spectrum for two different diversity branches may appear as shown in FIG. 9. Namely, one signal spectrum 500 includes a deep fade 502 at one RF frequency, and the other signal spectrum 504 includes a deep fade 506 at a different RF frequency.

Since the channel fading is frequency selective, choosing which branch to select preferably weighs the benefit to all of the OFDM subchannels. In general, it is much less desirable to simply compute the total power in the available branches and base the selection process on this kind of metric because this approach will clearly be susceptible to deep fades.

The following discussion sets forth an antenna branch selection method in accordance with an embodiment of the present invention. Preferably, the antenna branch selection method computations are performed during each MAC frame and the computed results are made use of in the immediately following frame. This alleviates the potential computational bottleneck of computing and using the computed results all during the same MAC frame. Such potential computational bottleneck can result from the extremely high peak computational load placed on the signal processing involved due to the receive branch selection processing having to be completed before the channel estimate is made. It should be well understood, however, that performing the antenna branch selection method computations during each MAC frame and using the computed results in the immediately following frame is not a requirement of the present invention.

With respect to the exemplary antenna branch selection method described herein, if two out of L-branches are selected for the case of n=2, the bit error probability for the complete OFDM symbol is given by:

$${Pb}_{i , j} = \frac{1}{K} {\sum }_{k = 1}^{K} min ( {Pb}_{i , k} , {Pb}_{j , k} ) \qquad ( 2 )$$

where K is the total number of OFDM sub-carriers and i and j represent the indices of the two antenna branches selected among L possible diversity branches. Therefore, in accordance with an embodiment of the present invention, the diversity antenna branch selection decision will be the antenna pair with indices i₀ and j₀ such that Pbᵢ_{₀}_{,j}_{₀} is minimized.

For binary phase-shift keying (BPSK) modulation, the bit error probability is:

$${Pb}_{BPSK} = Q ( \sqrt{\frac{2 {E}_{b}}{{N}_{0}}} ) \qquad ( 3 )$$

And for M-ary quadrature amplitude modulation (QAM), M ε{4,16,64}, the symbol error probability is:

$${Ps}_{M - QAM} = 1 - {( 1 - 2 ( 1 - \frac{1}{\sqrt{M}} ) Q ( \sqrt{\frac{3}{M - 1} \frac{{E}_{ave}}{{N}_{0}}} ) )}^{2} \qquad ( 4 )$$

where

$$\frac{{E}_{ave}}{{N}_{0}}$$

is the average SNR per symbol, and

$${P}_{\sqrt{M}} = 2 ( 1 - \frac{1}{\sqrt{M}} ) Q ( \sqrt{\frac{3}{M - 1} \frac{{E}_{ave}}{{N}_{0}}} ) \qquad ( 5 )$$

is the probability of error of a \sqrt{M}-ary pulse-amplitude modulation (PAM) with one-half the average power in each quadrature signal of the equivalent QAM system.

For simplicity, without considering gray encoding, any small bit error probability (≦3%) can be approximated with:

$${Pb}_{M - QAM} \approx \frac{Ps}{K} , where K = {log}_{2} M . \qquad ( 6 )$$

For fixed point application-specific integrated circuit (ASIC) implementation, Q(\sqrt{ax}) can be approximated with the following equations:

y=\sqrt{ax}≈\sqrt{a}*{max(|I|, |Q|)+0.375*min(|I|, |Q|)} (7)

Q(y)≈0.50−0.1x(4.4−x)0≦x≦2.2

0.01 2.2<x<2.6

0.0x≧2.6 (8)

This Q-function approximation results in a worst case absolute error of 0.0533. An alternative approach is to use a table lookup that covers the dynamic range for all modulation schemes (BPSK and M-QAM).

Because of the finite dynamic range in approximating Q(y) and the SNR \sqrt{Eₐᵥₑ/N₀} is approximated with \sqrt{I²+Q²} by the fast Fourier transforms (FFTs) in the receivers 104, 106 (FIG. 1), which is not actual SNR but signal plus noise, and with the assumption that channel fading patterns are changed slowly between consecutive MAC frames and remain flat (static) within each sub-carrier bandwidth, it suffices to select i and j such that the following quantity is minimized:

$${χ}_{i , j} = {\sum }_{k = 1}^{K} min \{ Q ( \sqrt{{[ \frac{{E}_{s - ave}}{{N}_{0}} ]}_{i}} ) , Q ( \sqrt{{[ \frac{{E}_{s - ave}}{{N}_{0}} ]}_{j}} ) \} \qquad ( 9 )$$

where Eₛ₋ₐᵥₑ/N₀ is the average SNR per symbol. Therefore, i=iₒ and j=jₒ are chosen such that χ_{io,jo} is minimized, with the antenna branches corresponding to iₒ and jₒ being the two selected branches.

An exemplary implementation of the antenna branch selection method of the present invention is based upon the evaluation of equation (9) to measure the probability of bit error metrics for all possible combinations or groupings of antenna branch pairs during a diversity selection portion of a MAC frame as described above. The calculated metrics are preferably used in the selection decision of the best antenna choice for the reception in the next MAC frame. As mentioned above, without this allowed delay, the computations required in a very short period of time (e.g., 5 OFDM symbols) are excessive.

In accordance with an embodiment of an antenna branch selection method of the present invention, measurements are taken from L different antenna branches n antenna branches at a time. The measurements are processed and are used to identify a group or combination of n of the L different antenna branches that are the best antenna branches in terms of signal quality. The identified group or combination of n antenna branches are then selected for the sub-carrier selection stage. In the illustrated case of n=2, a group of two antenna branches are identified and selected for use with the two RF receivers 104, 106 (FIG. 1). It should be understood that a group may include one or more antenna branches, which provides for n≧1.

In general, the best group or combination of n antenna branches are identified by identifying a group of n antenna branches that minimizes an approximated bit error probability of the final OFDM signal that will eventually be constructed during the sub-carrier selection stage. As will be discussed below, during the sub-carrier selection stage, each final OFDM sub-carrier is selected from the two receiving RF channels (for n=2) which have been coupled to the two selected antenna branches. To minimize the overall bit error rate, the sub-carrier selection stage makes decisions on a bin-by-bin basis, selecting the best sub-carriers from each receiving RF channel. But because the diversity antenna branch selection stage normally selects the best antenna branches prior to the sub-carrier selection stage, the selection is made by minimizing an approximated bit error probability of the final OFDM signal that will eventually be constructed from the OFDM sub-carriers that are each received by either one of the two identified best antenna branches. More generally, the best n antenna branches are selected by identifying a group of n of the L different antenna branches that minimizes an approximated bit error probability of a signal that will eventually be constructed from sub-carriers that are each received by any one of the n antenna branches in the identified group of n antenna branches.

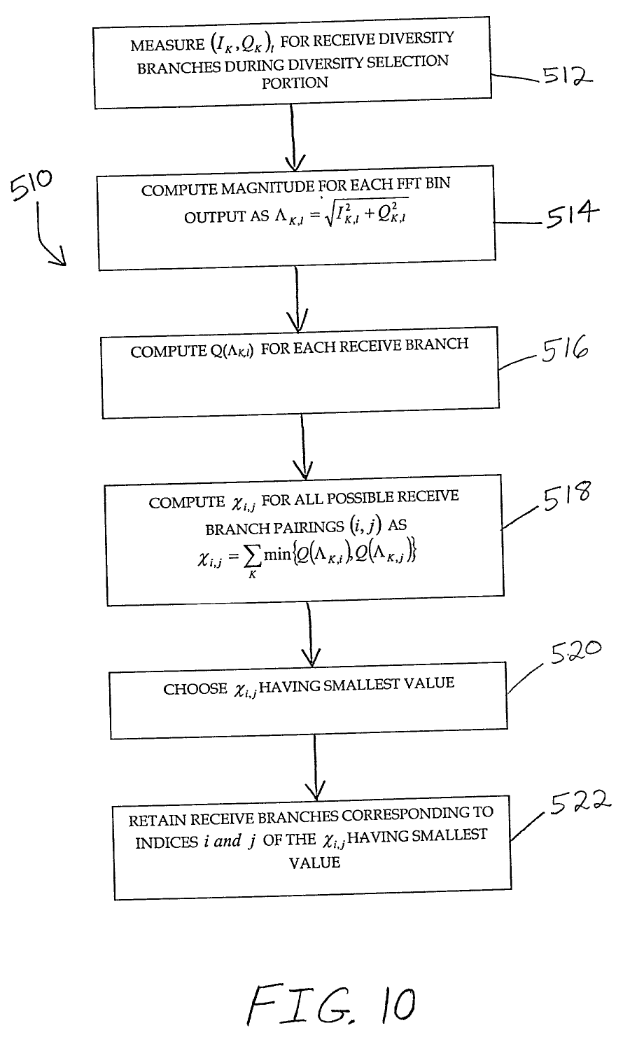

Accordingly, FIG. 10 illustrates an exemplary antenna branch selection method 510 in accordance with an embodiment of the present invention. Specifically, in step 512 the L different diversity antenna branches are measured n antenna branches at a time during the diversity selection portion of the MAC frame. The measurements are provided to the module 108 (FIG. 1) as the FFT outputs for each branch. The (I_{K},Q_{K}) measurements for the K^{th} FFT bin of the l^{th} receive branch are represented herein by (I_{K},Q_{K})ₗ. The measurements comprise power measurements of each of the K sub-carriers, i.e., FFT bin outputs.

In step 514 an approximate power magnitude for each FFT bin output is computed according to the following equation:

Λ_{K,l}=\sqrt{I²_{K,l}+Q²_{K,l}} (10)

All of the FFT bin values (signal strength for each bin) are preferably made using the same radio automatic gain control (AGC) setting. Gain differences between the two physical receive chains are addressed below. In step 516 approximate bit error probability values Q(Λ_{K,l}) are computed for each receive branch. The Q-function may be approximated as described above, using the appropriate approximate power magnitude as the argument. The approximate bit error probabilities, as well as the approximate power magnitudes computed in step 514, are preferably computed for each of the K sub-carriers for each of the L antenna branches, n antenna branches at a time.

In step 518 the chi values χ_{i,j} for all of the possible receive branch pairings (i, j) are computed as follows:

$${χ}_{i , j} = {\sum }_{K} min \{ Q ( {Λ}_{K , i} ) , Q ( {Λ}_{K , j} ) \} \qquad ( 11 )$$

Equation (11) basically selects a minimum one of the approximate bit error probabilities for each one of the K sub-carriers for each different grouping or combination of two antenna branches (n=2). The minimum ones of the approximated bit error probabilities are then summed for each different grouping or combination of two antenna branches. By way of example, for the n=2, L=4-branch case, the possible chi values that can be considered are χ_{1,2}, χ_{1,3}, χ_{1,4}, χ_{2,3}, χ_{2,4} and χ_{3,4}. In general, there are L(L-1)/2 different cases (chi values) to consider for an L-branch system.

Given the chi terms computed for a given evaluation interval, in step 520 the chi value χ_{i,j} having the smallest value is determined and the i, j indices saved. In other words, the sum of the minimum approximate bit error probabilities having the smallest value is determined. The i, j indices correspond to the receive branches that should be retained for best reception of the multipath-corrupted OFDM signal. In step 522 the receive branches corresponding to indices i and j of the chi value χ_{i,j} having the smallest value is retained for the duration of the next MAC frame. In this way, the grouping of n antenna branches that produced the sum of the minimum approximated bit error probabilities having the smallest value is selected.

For L>4, the number of terms and calculations becomes excessive, and it is preferable to only examine a subset of the different chi terms available. An approach in accordance with an embodiment of the present invention is to compute at most 6 chi-values, taking the worst 2 chi-values measured in each MAC frame and replacing them with measurements of 2 new possible receive branch pairings during the next MAC frame. In this manner, the routine automatically throws away the worst 2 branch pairings in its unending search to find 2 better branch pairings.

As an example, assume that L=5 receive branches are available. This means that there are a total of 5*4/2=10 possible chi values that need to be considered. Assume further that the best 6 chi terms are (in descending order of quality): χ_{1,2}, χ_{2,3}, χ_{1,4}, χ_{2,5}, χ_{4,5} and χ_{1,5}. During the next opportunity to evaluate the receiver branch selection metrics, the last two chi terms (χ_{4,5}, and χ_{1,5}) are dropped and two of the remaining pair possibilities are examined instead: χ_{1,3}, χ_{2,4}, χ_{3,4} and χ_{3,5}.

Thus, if there are L=6 antennas available, the diversity antenna selection can be based on 4 antennas' measurements (i.e., 6 chi terms) and then the remaining pairs are swapped with the other 2 worst antennas for the next diversity antenna selection in the next MAC frame.

The above-described computations may be executed for every different user stream being received by the system 100 (FIG. 1). Because many different user streams can be involved, the diversity antenna selection and sub-carrier selection diversity module 108 (FIG. 1) may be configured to keep track of the best indices pairs (i,j)ₘ for the m^{th} user stream. This is a very desirable capability in an access point or base station which purposely receives traffic from multiple concurrent user streams. Such configuration, however, is not a requirement of the present invention.

As mentioned above, if the signal gain through the (in the case of n=2) two receive chains is different for the same AGC setting, computation of the chi values χ_{i,j} in step 518 will be biased in favor of the receiver chain having the larger gain. In order to prevent this problem, the gain between the two receive chains involved may be accurately calibrated. One exemplary way to perform such a calibration is as follows. With the system 100 shown in FIG. 1, it is possible to switch any one of the L antenna branch inputs B1, B2, B3, B4, B5, B6 to either of the two receive chains 104, 106. Specifically, an antenna selection stage 101 is configured to allow each of the two RF receivers 104, 106 to be coupled to any one of the L different antenna branches B1, B2, B3, B4, B5, B6. The calibration between the two receive chains 104, 106 can then be done by measuring the signal power using one of the L branches connected to the first receive chain 104, and then quickly switching the same antenna branch to the second receive chain 106 and measuring the receive power a second time. This data can be used to compute an appropriate scale factor. Gain differences or AGC setting differences between the two physical receive chains 104, 106 can be compensated by multiplying Λ_{K,l} with the appropriate scale factor. In this way different receive chain signal gains can be dealt with so that all of the FFT bin signal strength measurements can be made using the same radio AGC setting.

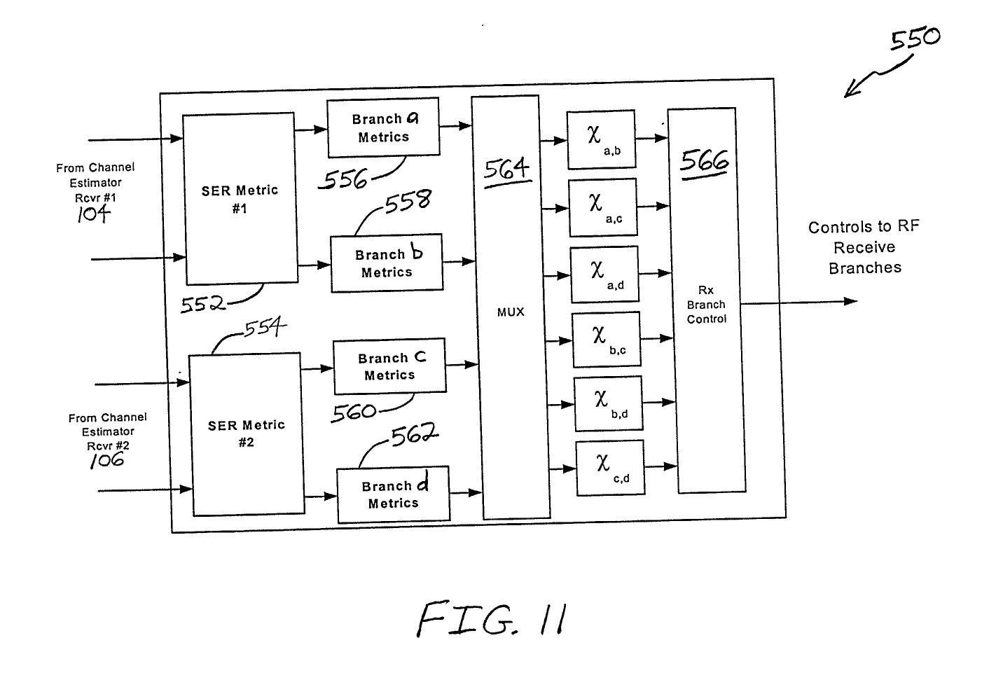

Referring to FIG. 11, there is illustrated a high-level block diagram of an exemplary diversity antenna branch selection module 550 made in accordance with an embodiment of the present invention. The module 550, which may be used in the diversity antenna selection and sub-carrier selection diversity module 108 (FIG. 1), is capable of operating in accordance with the antenna branch selection method 510 shown in FIG. 10. Specifically, when the L available receive diversity branches are measured during the diversity selection portion of the MAC frame pursuant to step 512 of the method 510, the channel estimates are provided to the Symbol Error Rate (SER) metric computation blocks 552, 554 as the FFT outputs from each of the RF receivers 104, 106 (FIG. 1). As mentioned above, the (Iₖ, Qₖ) measurements for the k^{th} FFT bin of the l^{th} receive branch are represented by (Iₖ, Qₖ)ₗ. These FFT estimates are made two at a time since in this case there are two complete RF receivers but L-branches (i.e., antennas) to consider.

The SER metric computation blocks 552, 554 perform steps 514 and 516 of the method 510 by computing the approximate power magnitude Λ_{k,l}=\sqrt{I_{k,l}²+Q_{k,l}²} and then the approximate bit error probability Q(Λ_{k,l}). The Q(Λ_{k,a}) values for antenna branch “a” are stored in branch a metrics 556, the Q(Λ_{k,b}) values for antenna branch “b” are stored in branch b metrics 558, the Q(Λ_{k,c}) values for antenna branch “c” are stored in branch c metrics 560, and the Q(Λ_{k,d}) values for antenna branch “d” are stored in branch d metrics 562.

A multiplexer 564 is used to form the possible receive antenna branch pairings or groupings from among the L different antenna branches for the execution of step 518. For example, in order to compute the chi value χ_{a,d}, the multiplexer 564 makes available the Q(Λ_{k,a}) values stored in branch a metrics 556 and the Q(Λ_{k,d}) values stored in branch d metrics 562 for calculation in the equation χ_{a,d}=Σmin{Q(Λ_{k,a}), Q(Λ_{k,d})}.

A receive branch control block 566 performs step 520 by determining the χ_{1,j} having the smallest value. The receive branch control block 566 then generates an output signal to control the RF receive branches to retain the braches corresponding to indices i and j of the χ_{i,j} having the smallest value for the execution of step 522.

The diversity antenna branch selection module 550 as shown in FIG. 11 is configured to examine L=4 different receive antenna branches at a time due to its capacity to calculate six different chi values χ_{i,j}. As described above, if more receive branches are available, the poorest 2 branches measured during the previous MAC interval can be replaced by using those measurement slots to examine 2 new branches, with the process continuing in this manner.

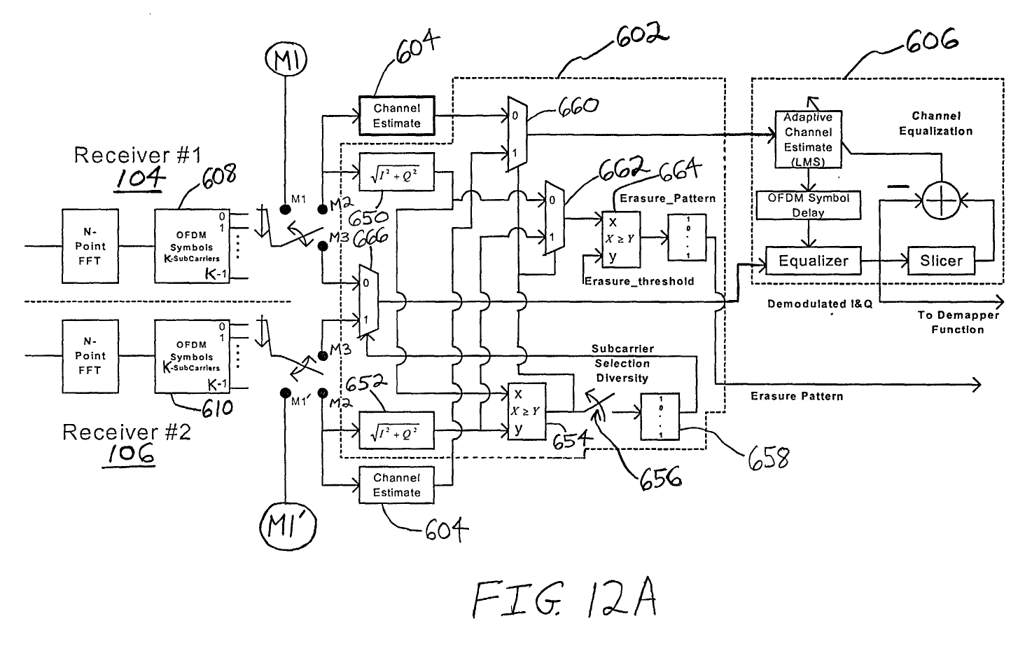

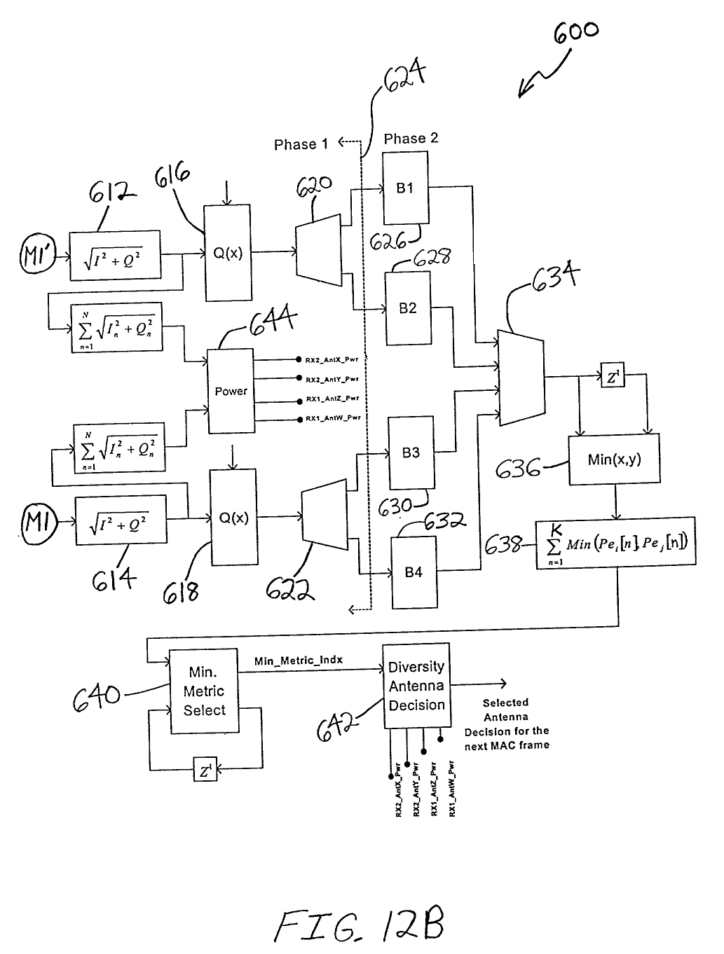

Referring to FIGS. 12A and 12B, there is illustrated exemplary implementations of a diversity antenna selection module 600 and a sub-carrier selection diversity module 602 made in accordance with embodiments of the present invention. The modules 600 and 602 may be used to form the diversity antenna selection and sub-carrier selection diversity module 108 (FIG. 1). The RF receivers 104, 106, channel estimate modules 604, and a channel equalization module 606 are also included in the figure for an overview of the system interfaces and interactions between these modules. The RF receivers 104, 106 include blocks 608, 610, respectively, illustrating the K sub-carriers of the OFDM signals. Each of the K sub-carriers may be coupled to the diversity antenna selection module 600, the channel estimate modules 604, or the sub-carrier selection diversity module 602 by means of nodes M1, M2, M3, respectively.

The diversity antenna branch selection module 600 operates in a manner similar to the diversity antenna branch selection module 550 (FIG. 11). The module 600 is configured to examine L=4 different receive antenna branches at a time, but it should be well-understood that the module 600 can be used to examine L>4 different receive antenna branches by dropping one or more of the poorest branches measured during the previous MAC interval and using those measurement slots to examine new branches as described above.

The antenna diversity processing can be sub-divided into two phases: the real time Phase1 (to the left of dotted line 624) and the non-real time Phase2 (to the right of dotted line 624). Phase1 may also be referred to as a first computation stage, and Phase2 may also be referred to as a second computation stage.

Phase1 preferably runs during the reception of the diversity selection portion of the MAC frame. The L available receive diversity branches are measured during the diversity selection portion of the MAC frame pursuant to step 512 of the method 510 (FIG. 10) by coupling the K sub-carriers of the OFDM signals to the diversity antenna selection module 600 by means of nodes M1, M1′. The channel estimates (Iₖ, Qₖ)ₗ are provided to the power measurement blocks 612, 614, which perform step 514 of the method 510 by computing Λ_{k,l}=\sqrt{I_{k,l}²+Q_{k,l}²}. The computation blocks 616, 618 perform step 516 of the method 510 by computing Q(Λ_{k,l}). Thus, the power measurement blocks 612, 614 are configured to compute an approximate power magnitude for each of the K sub-carriers, and the computation blocks 616, 618 are configured to process the approximate power magnitudes by approximating the Q-function.

The antenna switch multiplexer 620 multiplexes the Q(Λ_{k,l}) data between memory 626 and memory 628, and the antenna switch multiplexer 622 multiplexes the Q(Λ_{k,l}) data between memory 630 and memory 632. The memories 626, 628, 630, 632, which may comprise random access memories (RAMs), are used to store intermediate metric values for non-real time processing. By way of example, the memories 626, 628, 630, 632 may each be capable of storing K measurements, where K is the number of sub-carriers (e.g., K=52, 68, 84, or 100). This way, each of the four memories 626, 628, 630, 632 can be used to store the approximate probability bit error metrics Q(Λ_{k,l}) for one of the L=4 antenna branches. Namely, memory 626 stores the Q(Λ_{k,1}) data for antenna branch B1, memory 628 stores the Q(Λ_{k,2}) data for antenna branch B2, memory 630 stores the Q(Λ_{k,3}) data for antenna branch B3, and memory 632 stores the Q(Λ_{k,4}) data for antenna branch B4. When the last metric value is stored in memory 632, all of the blocks in Phase1 become inactive.

In Phase2, the multiplexer 634 sequentially multiplexes different combinations or groupings of the Q(Λ_{k,l}) data stored in the memories 626, 628, 630, 632 to begin the calculation of the chi values χ_{i,j} pursuant to step 518 of the method 510. In this way the multiplexer 634 forms different groupings of n antenna branches from among the L different antenna branches. The minimum value of each combination of the Q(Λ_{k,l}) data is determined in the minimum function computation block 636, which selects a minimum one of the approximate bit error probabilities for each one of the K sub-carriers for each different grouping of n antenna branches. The summation operation is performed in summation computation block 638, which sums the minimum ones of the approximate bit error probabilities that were selected for each one of the K sub-carriers for each different grouping of n antenna branches.

The chi value χ_{i,j} having the smallest value is determined by a minimum metric selection module 640 pursuant to step 520 of the method 510. A diversity antenna selection decision module 642 generates an output signal to indicate the selected antenna decision for the next MAC frame pursuant to step 522 of the method 510. This output signal controls the RF receive branches to retain the branches corresponding to indices i and j of the χ_{i,j} having the smallest value.

A power block 644 may be used to store intermediate power values for non-real time processing. By way of example, the power block 644 may include four memory locations for holding the average amplitudes of the power magnitudes of the FFT bins for the four antenna branches B1, B2, B3, B4 (with one measurement per antenna branch). In the case of when there is one dominant branch, the metrics of all the possible combination antenna pairs may all be derived from the same antenna and result in the same value. The power metrics are then used in the selection decision process to ensure the selected antenna pair corresponds to the best antenna choice for the second receiver.

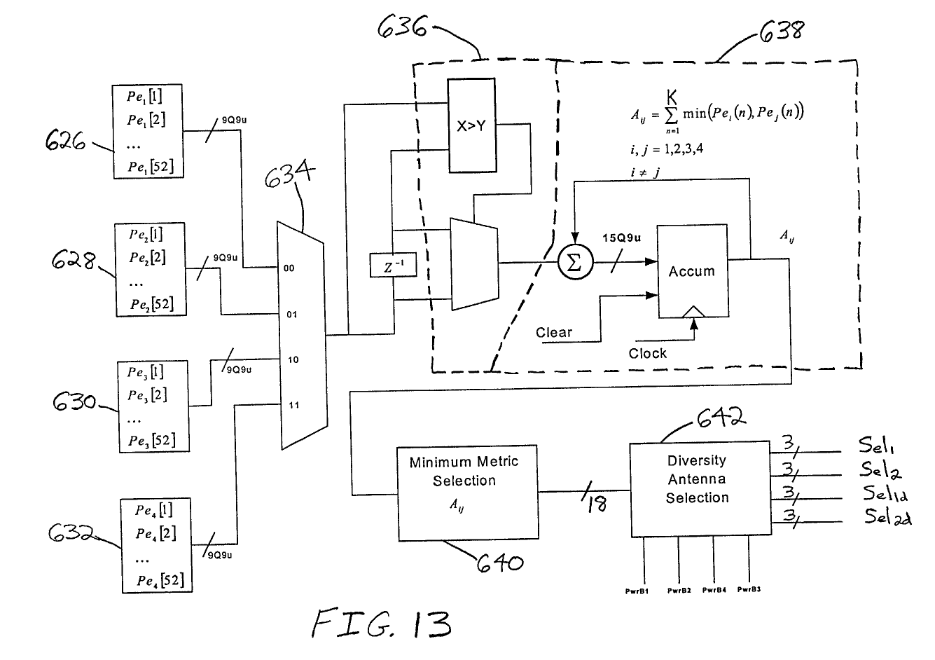

Referring to FIG. 13, the minimum metric selection module 640 reports the i & j indices that correspond to the smallest metric. By way of example, the i & j indices that correspond to the smallest metric may be encoded with 3 bits. The output is packed into an 18-bit word for the worst case of three antenna pairs with equal metrics for the L=6 case. A “000” index may be used as a filler when there are only one or two antenna pairs selected.

A programmable register may be used for initialization in the diversity antenna selection decision module 642 for the first received MAC frame after the unit is powered up. The antenna branches with indices Sel₁ and Sel₂ are used in the reception of the data portion, and the antenna branches with indices Sel₁, Sel₂, Sel_{1d}, Sel_{2d} are used in the diversity antenna selection in the next MAC frame.

After the two antenna branches have been selected (in the n=2 scenario) from among the L antenna branches in the diversity antenna branch selection stage, the sub-carrier selection stage starts processing. As mentioned above, FIG. 12A illustrates an exemplary implementation of a sub-carrier selection diversity module 602 made in accordance with an embodiment of the present invention. The received OFDM symbols consist of many sub-carriers which experience different frequency selective channel fading patterns. In the sub-carrier selection stage, each final OFDM sub-carrier is selected from the two receiving RF channels which have been coupled to the two selected antenna branches. To minimize the overall bit error rate, the sub-carrier selection stage makes decisions on a bin-by-bin basis among all the available receiving paths.

Upon the availability of the FFT of the long training symbols, the sub-carrier selection stage starts processing. The sub-carrier selection decision is preferably based on the power measurements of the long training symbols. In other words, decisions are preferably made on a bin-by-bin basis by selecting winning bins with larger Λ_{k,l} between the two available branches, where Λ_{K,l} are measured on the FFT bins of the long training symbols.

These selections are made as follows. During the reception of the long training symbols, the FFT output switch is in the M2 position. The power of each sub-carrier, i.e., the magnitude of each FFT bin, is computed by power measurement blocks 650, 652. The power measurement block 650 computes the power of the sub-carriers from the first receiver 104, and the power measurement block 652 computes the power of the sub-carriers from the second receiver 106. The powers computed by the power measurement blocks 650, 652 are compared with each other in a comparator 654. A decision of “0” is output from the comparator 654 if the power of a sub-carrier from the first receiver 104 is greater; otherwise, a “1” is output. While these comparisons are being made the switch 656 is closed and the results, i.e., the “0” and “1” outputs from the comparator 654, are stored in a memory 658.

While the FFT output switch is still in the M2 position and the sub-carrier selection decisions are being made by the comparator 654, the output of the comparator 654 may be provided to a multiplexer 660 so that the sub-carrier selection decisions can be used to multiplex the channel estimates from the channel estimate modules 604. The output of the comparator 654 may also be provided to a multiplexer 662 so that erasures for a signal constellation demapping function can be declared in the case of very poor SNR on individual bins. The power of the winning bins may be compared by a comparator 664 with an erasure threshold in assigning the erasure declarations.

During the reception of the data portion, the FFT output switch is moved to position M3 and the switch 656 at the output of the comparator 654 is opened. The sequence of 0's and 1's that were recorded in the memory 658 for each frame are preferably used as a switch for a multiplexer 666 to multiplex the incoming channel estimates and I's and Q's samples output from the FFT. In other words, the sub-carrier selection decisions stored in the memory 658 are preferably used to control the multiplexer 666 to multiplex the subsequent OFDM sub-carrier data into the channel equalization module 606.

Thus, the final OFDM signal is constructed from the OFDM sub-carriers that are each received by either one of the two selected best antenna branches. The sequence of 0's and 1's that are stored in the memory 658 for each frame are used to identify which of the two antenna branches is receiving the better quality sub-carrier for each different value of K. The better one of the two sub-carriers for each value of K is multiplexed into the final OFDM signal by the multiplexer 666. By constructing the final OFDM signal with sub-carriers received by the two best antenna branches selected by the diversity antenna selection module 600, the final OFDM signal should have an approximate bit error probability that is smaller than it would have been if a different pairing of antenna branches were used. In this way the diversity antenna selection module 600 and the sub-carrier selection diversity module 602 help to reduce the effects of frequency-selective fading in OFDM communications. This makes the system 100 (FIG. 1) highly tolerant to multipath propagation and narrowband interference.

While the invention herein disclosed has been described by means of specific embodiments and applications thereof, numerous modifications and variations could be made thereto by those skilled in the art without departing from the scope of the invention set forth in the claims.

What is claimed is:

1. A method of performing diversity antenna selection, comprising the steps of:
taking measurements from L different antenna branches n antenna branches at a time;
using the measurements to identify a group of n of the L different antenna branches that minimizes an approximate bit error probability of a signal that will eventually be constructed from sub-carriers that are each received by any one of the n antenna branches in the identified group of n antenna branches; and
selecting the identified group of n antenna branches.

2. A method in accordance with claim 1, wherein the measurements comprise power measurements of each of K sub-carriers.

3. A method in accordance with claim 2, wherein the step of using the measurements to identify a group of n of the L different antenna branches further comprises the step of:
computing an approximate bit error probability for each of the K sub-carriers for each of the L antenna branches n antenna branches at a time.

4. A method in accordance with claim 3, wherein the step of using the measurements to identify a group of n of the L different antenna branches further comprises the steps of:
forming different groupings of n antenna branches from among the L different antenna branches; and
for each different grouping of n antenna branches, selecting a minimum one of the approximate bit error probabilities for each one of the K sub-carriers.

5. A method in accordance with claim 4, wherein the step of using the measurements to identify a group of n of the L different antenna branches further comprises the step of:
for each different grouping of n antenna branches, summing the minimum ones of the approximate bit error probabilities that were selected for each one of the K sub-carriers.

6. A method in accordance with claim 5, wherein the step of using the measurements to identify a group of n of the L different antenna branches further comprises the steps of:
determining which sum of the minimum ones of the approximate bit error probabilities has a smallest value; and
selecting the grouping of n antenna branches that produced the sum of the minimum ones of the approximate bit error probabilities having the smallest value.

7. A method in accordance with claim 1, further comprising the step of:
calibrating a gain between n radio frequency (RF) receive paths.

8. A method in accordance with claim 7, wherein the step of calibrating a gain between n RF receive paths further comprises the steps of:
measuring a signal power received by a first one of the L antenna branches with a first receive path; and
measuring the signal power received by the first one of the L antenna branches with a second receive path.

9. A method in accordance with claim 3, wherein the step of computing an approximate bit error probability for each of the K sub-carriers for each of the L antenna branches n antenna branches at a time further comprises the step of:
computing an approximate power magnitude for each of the K sub-carriers for each of the L antenna branches n antenna branches at a time based on the power measurements.

10. A method in accordance with claim 9, wherein the step of computing an approximate bit error probability for each of the K sub-carriers for each of the L antenna branches n antenna branches at a time further comprises the step of:
approximating a Q-function for each of the K sub-carriers for each of the L antenna branches n antenna branches at a time with a corresponding approximate power magnitude comprising an argument thereof.

11. A method in accordance with claim 3, wherein the step of using the measurements to identify a group of n of the L different antenna branches further comprises the step of:
storing the computed approximate bit error probabilities.

12. A method in accordance with claim 4, wherein the step of forming different groupings of n antenna branches from among the L different antenna branches comprises the step of:
multiplexing approximate bit error probabilities corresponding to n antenna branches.

13. A method in accordance with claim 2, wherein the K sub-carriers form an orthogonal frequency division multiplexing (OFDM) signal.

14. A method in accordance with claim 1, wherein the step of taking measurements from L different antenna branches n antenna branches at a time comprises the steps of:
receiving a frame that includes a diversity selection portion comprising one or more antenna branch probing portions; and
taking measurements from n antenna branches during one of the antenna branch probing portions.

15. A method in accordance with claim 14, wherein the step taking measurements from n antenna branches during one of the antenna branch probing portions comprises the step of:
taking measurements from each one of the n antenna branches with a separate one of n radio frequency receivers.

16. A method in accordance with claim 1, further comprising the step of:
constructing an output signal from sub-carriers that are each received by any one of the n antenna branches in the selected identified group of n antenna branches.

17. A method in accordance with claim 16, wherein the step of constructing an output signal from sub-carriers comprises the steps of:
computing an approximate power magnitude for each of K sub-carriers for each of the n antenna branches in the selected identified group of n antenna branches; and
comparing the approximate power magnitudes for each of the K sub-carriers for each of the n antenna branches in the selected identified group of n antenna branches with the approximate power magnitudes for each of the respective K sub-carriers for each of the other n antenna branches in the selected identified group of n antenna branches.

18. A method in accordance with claim 17, wherein the step of constructing an output signal from sub-carriers further comprises the step of:
based on results of the comparing step, selecting sub-carriers from one or more of the n antenna branches in the selected identified group of n antenna branches to form the output signal.

19. A method in accordance with claim 18, wherein the step of constructing an output signal from sub-carriers further comprises the step of:
storing results of the comparing step.

20. An apparatus that includes a diversity antenna selection module, wherein the diversity antenna selection module comprises:
a first computation stage configured to compute an approximate bit error probability for each of K sub-carriers for each of L different antenna branches n antenna branches at a time; and
a second computation stage configured to process the approximate bit error probabilities to identify a group of n of the L different antenna branches that minimizes an approximate bit error probability of a signal that will eventually be constructed from sub-carriers that are each received by any one of the n antenna branches in the identified group of n antenna branches.

21. An apparatus in accordance with claim 20, wherein the second computation stage further comprises:
a multiplexer configured to form different groupings of n antenna branches from among the L different antenna branches; and
a minimum function stage configured to select a minimum one of the approximate bit error probabilities for each one of the K sub-carriers for each different grouping of n antenna branches.

22. An apparatus in accordance with claim 21, wherein the second computation stage further comprises:
a summation stage configured to sum the minimum ones of the approximate bit error probabilities that were selected for each one of the K sub-carriers for each different grouping of n antenna branches.

23. An apparatus in accordance with claim 22, wherein the second computation stage further comprises:
a minimum metric selection stage configured to determine which sum of the minimum ones of the approximate bit error probabilities has a smallest value; and
a diversity antenna decision stage configured to select the grouping of n antenna branches that produced the sum of the minimum ones of the approximate bit error probabilities having the smallest value.

24. An apparatus in accordance with claim 20, wherein the second computation stage further comprises:
memories for storing the computed approximate bit error probabilities.

25. An apparatus in accordance with claim 20, wherein the first computation stage further comprises:
n power measurement stages each configured to compute an approximate power magnitude for each of K sub-carriers.

26. An apparatus in accordance with claim 25, wherein the first computation stage further comprises:
n Q-function stages each configured to process approximate power magnitudes.

27. An apparatus in accordance with claim 20, further comprising:
n radio frequency receivers coupled to the diversity antenna selection module.

28. An apparatus in accordance with claim 20, further comprising:
an antenna selection stage configured to allow each of n different radio frequency receivers to be coupled to any one of the L different antenna branches.

29. An apparatus in accordance with claim 20, further comprising:
a diversity antenna structure having L different antenna branches.

30. An apparatus in accordance with claim 20, further comprising:
a sub-carrier selection diversity module configured to construct an output signal from sub-carriers that are each received by any one of the n antenna branches in the identified group of n antenna branches.

31. An apparatus in accordance with claim 30, wherein the sub-carrier selection diversity module comprises:
n power measurement stages each configured to compute an approximate power magnitude for each of K sub-carriers for one of the n antenna branches in the identified group of n antenna branches; and
a comparator configured to compare the approximate power magnitudes for each of the K sub-carriers for each of the n antenna branches in the identified group of n antenna branches with the approximate power magnitudes for each of the respective K sub-carriers for each of the other n antenna branches in the identified group of n antenna branches.

32. An apparatus in accordance with claim 31, wherein the sub-carrier selection diversity module further comprises:
a multiplexer configured to select sub-carriers from one or more of the n antenna branches in the identified group of n antenna branches based on data generated by the comparator to form the output signal.

33. An apparatus in accordance with claim 32, wherein the sub-carrier selection diversity module further comprises:
a memory configured to store the data generated by the comparator.

34. A diversity antenna selection module, comprising:
means for taking measurements from L different antenna branches n antenna branches at a time;
means for using the measurements to identify a group of n of the L different antenna branches that minimizes an approximate bit error probability of a signal that will eventually be constructed from sub-carriers that are each received by any one of the n antenna branches in the identified group of n antenna branches; and
means for selecting the identified group of n antenna branches.

35. A diversity antenna selection module in accordance with claim 34, wherein the measurements comprise power measurements of each of K sub-carriers.

36. A diversity antenna selection module in accordance with claim 35, wherein the means for using the measurements to identify a group of n of the L different antenna branches further comprises:
means for computing an approximate bit error probability for each of the K sub-carriers for each of the L antenna branches n antenna branches at a time.

37. A diversity antenna selection module in accordance with claim 36, wherein the means for using the measurements to identify a group of n of the L different antenna branches further comprises:
means for forming different groupings of n antenna branches from among the L different antenna branches; and
means for selecting a minimum one of the approximate bit error probabilities for each one of the K sub-carriers for each different grouping of n antenna branches.

38. A diversity antenna selection module in accordance with claim 37, wherein the means for using the measurements to identify a group of n of the L different antenna branches further comprises:
means for summing the minimum ones of the approximate bit error probabilities that were selected for each one of the K sub-carriers for each different grouping of n antenna branches.

39. A diversity antenna selection module in accordance with claim 38, wherein the means for using the measurements to identify a group of n of the L different antenna branches further comprises:
means for determining which sum of the minimum ones of the approximate bit error probabilities has a smallest value; and
means for selecting the grouping of n antenna branches that produced the sum of the minimum ones of the approximate bit error probabilities having the smallest value.

40. A diversity antenna selection module in accordance with claim 34, further comprising:
means for calibrating a gain between n radio frequency (RF) receive paths.

41. A diversity antenna selection module in accordance with claim 40, wherein the means for calibrating a gain between n RF receive paths comprises:
means for measuring a signal power received by a first one of the L antenna branches with a first receive path; and
means for measuring the signal power received by the first one of the L antenna branches with a second receive path.

42. A diversity antenna selection module in accordance with claim 34, wherein the means for taking measurements from L different antenna branches n antenna branches at a time comprises:
means for receiving a frame that includes a diversity selection portion comprising one or more antenna branch probing portions; and
means for taking measurements from n antenna branches during one of the antenna branch probing portions.

43. A diversity antenna selection module in accordance with claim 42, wherein the means for taking measurements from n antenna branches during one of the antenna branch probing portions comprises:
n radio frequency receivers with each one being configured to take measurements from one of the n antenna branches during one of the antenna branch probing portions.
